(19) United States
(12) Patent Application Publication
(10) Pub. No.: US 2005/0027814 A1
(43) Pub. Date: Feb. 3, 2005

(54) Navigation system and method for using the same

(76) Inventors: James Norman, Tampa, FL (US); J. Stephan Dolezalek, Portola Valley, CA (US)

Correspondence Address: Alan H. Norman;Thompson Coburn LLP, One US Bank Plaza, St. Louis, MO, 63101-9928, US

(21) Appl. No.: 10/885,541

(22) Filed: Jul. 6, 2004

Related U.S. Application Data
(63) Continuation of application No. 09/547,781, filed on Apr. 12, 2000, now abandoned.

(51) Int. Cl. G06F 15/16

(52) U.S. Cl. 709/211; 709/219

(57) ABSTRACT

A navigation and cataloging system is described. In one embodiment, the navigation and cataloging system comprises a database and a server. The database stores content that is associated with a combination of locational information from a series of diagrams (which function as decision trees or flow diagrams) and from standardized, but specific categories of information typically sought by users of that particular type of information (e.g., technology, law, medicine, travel, etc.). Each location on the diagram is cross-indexed with a category of information and that combination leads to specific information being requested from the database. The server retrieves content in response to a request. The request has a context based on which diagram is showing on a display, a selection of a location on the diagram, and a selection of the category of content. In its cataloging role, the system provides the context, and thereby the unique location, to which content can and should be associated.

### CROSS-REFERENCE TO RELATED APPLICATIONS

This is a continuation of U.S. patent application Ser. No. 09/547,781 filed Apr. 12, 2000 entitled A Navigation System and Method for Using the Same (incorporated herein by reference).

### FIELD OF THE INVENTION

The present invention relates to providing access to information, goods and services and other related information through a network; more particularly, the present invention relates to a navigation and cataloging system that provides access to information, goods and services based on a user specified context and provides a unique contextual locus for the storage of technically complex information.

### BACKGROUND OF THE INVENTION

The Internet is a rich source of information on a wide variety of subjects. Many such subjects, however, are both technically complex and involve terms of art, such as the fields of medicine, law and technology. Internet sites focused on these more complex areas, as for other areas of consumer interest, sprung up all over the World Wide Web (hereinafter the “web”). For example, there are currently more than 30,000 “healthcare.com's” on the Internet. Users of all types of web sites, and particularly those focused on more technical subject matter, have discovered that the information on existing sites is confusing, disorganized, and completely without context. As a result, even highly valuable information can be extremely difficult to access. This is particularly true when such information is cataloged through the use of technical terminology or terms of art, as is often the case with medical or legal subject matter. Key to accessing such information becomes the search methodology employed to connect the user to the subject matter of interest.

Traditionally, web sites have relied upon the use of “keywords” in the manner popularized first by organizations such as Lexis/Nexis and more recently sites such as Yahoo/Excite/InfoSeek. As a result, information is cataloged either by one or more “subject area reference words” or by individual “keywords” appearing somewhere in the content. If one knows the right keyword, one can find the information. Unfortunately, as more and more web users are discovering, such keywords can be over or under-inclusive, they can be difficult to zero in on, and, if a technical subject is involved, the layperson and the specialist may use two different words to describe the same subject matter.

As a result, a common problem with individuals locating information on the Internet is the limited background such individuals have to enable them to find information which is appropriate to the specific situation in which they find themselves. A user searching for information on “networks” for the home is actually looking for something quite different than the person searching for “networks” for a large organization. An individual searching for information on personal “bankruptcy” doesn't need or want all the information available on corporate bankruptcy. This distinction is particularly acute for patients who are searching for particular information on a specific disease or symptom(s). Here, the individual searches not only for specific technical information that may be cataloged according to differing terminology, they also need to have that information be relevant to where they actually are in the progression of a particular disease or physical state, i.e. pregnancy.

The same difficulty applies to those attempting to make technical information available on the web. Under current methodologies, content producers must identify the keywords under which they hope to have their content cataloged by search engines and other search methodologies. In a two dimensional world, people are used to putting information about Chicago near its location on a map of Illinois. In the internet, such locational maps to allow, both searching for information and “hanging content” a locational and contextual mapping system, thereby providing the same benefits as more traditional geographic mapping, do not exist.

### SUMMARY OF THE INVENTION

Systems for navigating and cataloging content are described. In one embodiment, the system comprises a database and a server. The database stores content containing multiple diagrams and at least one specific category of information and/or activity associated with distinct locations on one or more diagrams. The server retrieves and supplies content in response to a request having a context based on which diagram is showing on a display, a selection of a location on the diagram, and a selection on a location on an interface on the display specifying at least one category of content and/or activity associated with and specific to the selected location on the diagram. This enables content associated with the context to be provided in response to the request and/or enables the desired activity to occur within the context of the selected location.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates an exemplary health map for clinical stage II melanoma.

FIG. 2 illustrates another exemplary health map on malignant melanoma.

FIG. 3A illustrates an example interface having a series of buttons.

FIG. 3B shows a page that is displayed that includes trusted content.

FIG. 4 is a flow diagram of a process for navigating a site to obtain specific content.

FIG. 5 is a block diagram of one embodiment of a navigation system.

FIG. 6 is a block diagram of one embodiment of a network environment.

FIG. 7 is a block diagram of an exemplary computer system.

### DETAILED DESCRIPTION

A navigation and cataloging system is described. In one embodiment, the navigation and cataloging system comprises a database and a server. The database stores content that is associated with a combination of locational information from a series of diagrams (which function as decision trees or flow diagrams) and from standardized, but specific categories of information typically sought by users of that particular type of information (e.g., technology, law, medicine, travel, etc.). Each location on the diagram is cross-indexed with a category of information and that combination leads to specific information being requested from the database. The server retrieves content in response to a request. The request has a context based on which diagram is showing on a display, a selection of a location on the diagram, and a selection of the category of content. In its cataloging role, the system provides the context, and thereby the unique location, to which content can and should be associated.

It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Overview

A graphical user interface and navigation and cataloging system are described that allows the user of a web site to quickly and accurately find specific information, goods, and services within a field of interest within the context of the specific course of events or current needs of the user. The same system provides the author or developer of content relating to such information, goods or services with a unique, coherent locus for attaching the content they have developed. In one embodiment, the graphical interface takes the form of a map or flow diagram that both guides the user to a particular point of interest and provides the contextual information from which to make locational decisions (e.g., each fork in the pathway provides an instantaneous sort of what future choices remain relevant). Once a particular point of interest is arrived at or selected, the user selects a desired “activity.” Such “activity” might be to shop, to chat, to read and learn, to find other common users, etc. These “activities” tend to be generic to the web site in question in that what one does within the context of a medical site differs from the activities common to a computer store, a legal site or a travel site. However, it is the cross indexing of the locational information and the desired “activity” which assigns the database information to obtain the appropriate content or makes available an attachment point for new content.

Entire industries, processes, devices, and services may be mapped in such a fashion using multiple interconnected maps. The navigation system provides a graphical user interface to facilitate retrieval and navigation through the mapping system.

Maps can take on any graphical shape or structure, but typically will allow the user to navigate quickly to the field of interest and then to position him/herself on a particular point or points within the graphical interface according to the current need of the user. The map allows the users to find their point of interest by examining the graphical interface and following visual cues. In one embodiment, the system of the map is based on the need of the user and the type of information, goods, and/or services being accessed. The map may be series of blocks or diagrams such as in a flow chart, or they may be a series of connecting lines and words. In yet another embodiment, the map may resemble an ordinary geographic map or a planar map of a building.

Users of the navigational system are (i) those seeking information, goods, services, and other attributes of a particular field or (ii) those seeking to provide content to users of the internet in a contextual environment. The field may be any area of concern or interest, including, but not limited to, healthcare, computers, travel, finance, business, law, agriculture, communications, retail sales, wholesale sales, food, entertainment, or any other type of information compository. In one embodiment, with the field being healthcare, the users of the navigation system include all constituents of the healthcare system, including, but not limited to, payers, employers, hospitals, clinics, universities, governments, associations, pharmaceutical and device manufactures, sales representatives, doctors and other health care providers, and patients.

The navigation system comprises at least one client system and at least one server system in a networked environment. In one embodiment, clients and servers are in the Web and the coupling is via the Internet. There may be multiple clients and servers. An exemplary client and a network architecture are described in greater detail below.

In one embodiment, using the navigation system, an individual may obtain health care information stored in a database of the server using a retrieval system. In one embodiment, the retrieval system comprises a database search engine (e.g., Broadvision, Verity, etc.). The information stored in the database comprises many types of healthcare information related to various ailments, conditions, services, drugs, devices, financials, and other pertinent topics.

In one embodiment, large and complex subject areas such as healthcare can be mapped as described above to enable a typical user to (i) rapidly narrow the field of information, (ii) find information specific to a particular state of health or disease, and (iii) within the context of that specific disease state to locate goods and services of interest to that patient at that point in his/her disease.

That is, in the case of healthcare, the maps comprise a series of diagrams that first associate information into larger contextual fields, such as Cancer or Cardiovascular diseases, then into more specific contexts such as Prostate Cancer or Heart Disease, then into the progression of a single disease, showing the logical progression of symptoms, diagnosis, or treatments, or other graphical representation of the information stored in one or more databases. At each level of increasing detail, the user can select an activity, such as find a doctor, chat with another patient, shop a mini kiosk, etc. Such health maps may, but not exclusively, take the form of a flow diagram illustrating diagnostic, therapeutic, and treatment steps in an ailment or condition. Other maps may show the expected course of events within any disease process or condition over time (e.g., pregnancy or child-rearing) such that the user could access specifically such time sensitive issues. Each disease or condition may have one or many (e.g., dozens) of interconnecting maps that put targeted information into context that is specific for every stage or treatment of each medical condition. In one embodiment, maps reference each other to create a hierarchal tree of maps in a mapping system. Thus, the graphical user interface provides individuals with health maps that allow them to follow their way through a disease and/or treatment process as they would navigate their way along a city map. A key distinction with the prior art is that each such map is directly matrixed to an activity of choice and the user both navigates and chooses the activity they intend to perform at their destination.

In one embodiment, certain health maps include an interface by which an individual may access knowledge of how medical conditions are diagnosed, treatment options, drugs and devices used in the treatment, ongoing research trials, and other goods and services pertinent to that condition in that specific context.

In one embodiment, each health map is a dynamic tool or cataloging system that is changed and is updated by the user. For example, the health map navigational process may allow healthcare providers (e.g., licensed physicians) to attach their expertise (e.g., knowledge, services, etc.) to a position on the map to which such expertise is related. In such a case, the licensed physician is provided with a page to insert text or attach one or more documents after being authenticated (e.g., via entry and specific information, such as their physician number). Therefore, content may be added into the system for others to access.

The navigation system allows communities to be created, each dedicated to a small, specific segment of area of interest, be that a geographic location (e.g., the Swiss Alps), an area of interest (e.g., constitutional law), an area of technology (e.g., optical networking), or a health care condition (e.g., cervical carcinoma). With the navigation system, users become members of a community defined by their choice of location, that spot on the map (e.g., geographic map, the technology map, the health map, etc.), or portion thereof, on which they reside. As a result, each node on the map becomes a virtual community, a place to exchange ideas, to shop, to chat, to do research, to find other members of the same discrete virtual community. Much as establishing a real community involves “putting it on the map,” building the first residences and stores, and then allowing the rest of what constitutes a true community to develop at that location, the virtual communities described by this navigational system involve first establishing a “known location” for the community, then establishing a starter set of activities for that location—the virtual library, the store, the community room and the directory for finding others in that community.

In one embodiment, the navigation system is designed to allow content to be attached to information flows. This concept will be described more detail below.

An Exemplary Health Map

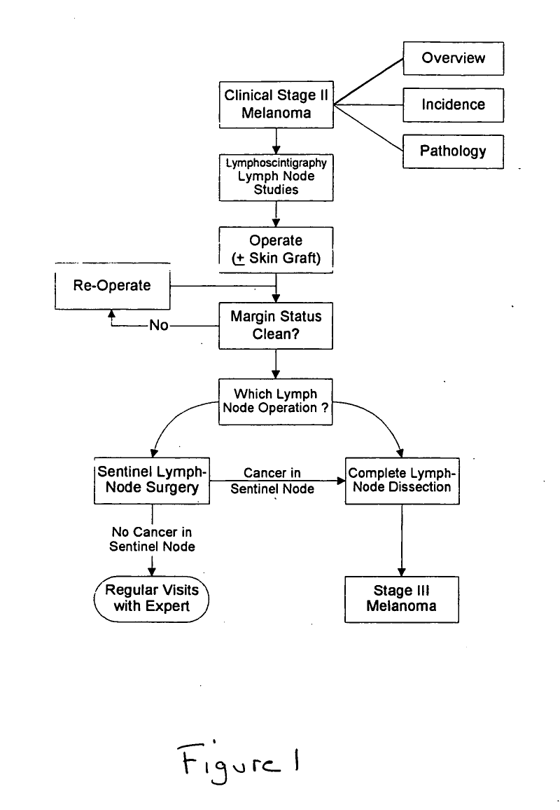

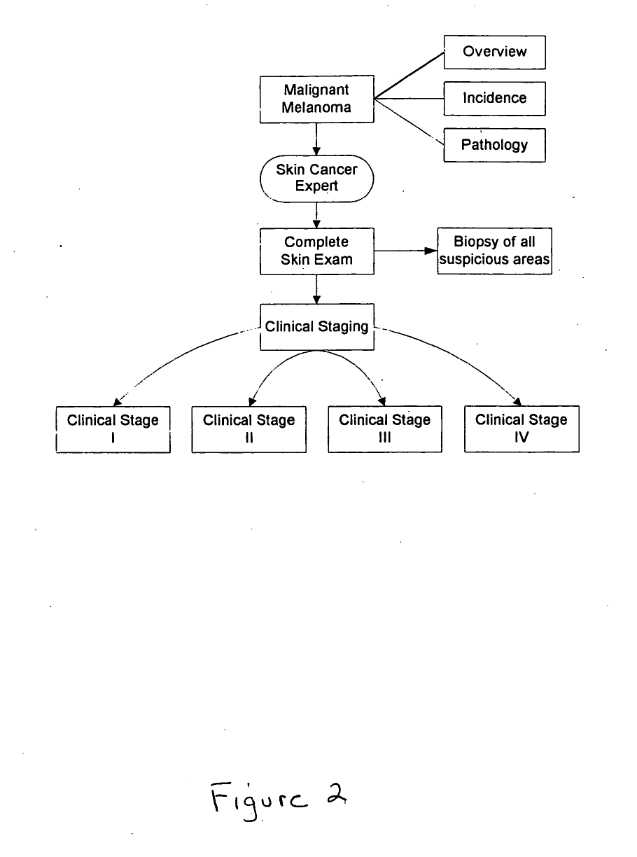

FIG. 1 illustrates an exemplary health map for clinical stage II melanoma. A user of the navigation system may have arrived at the health map of FIG. 1 in any of a number of ways. In one embodiment, an individual may have arrived at the health map by selecting a block in another health map. For example, if an individual was viewing a health map on malignant melanoma such as FIG. 2 and selected clinical stage II malignant melanoma block 201, then the health map for clinical stage II malignant melanoma is displayed. In another embodiment, the individual may have arrived at the health map of FIG. 1 by entering an ICD and/or CPT code. For more information on the use of ICD or CPT codes, see U.S. patent application Ser. No. 09/425,779, entitled “Apparatus and Method for Directing Internet Users to Health Care Information,” filed Oct. 22, 1999, now U.S. Pat. No. 6,738,754 (incorporated herein by reference) and assigned to the corporate assignee of the present invention. In still another embodiment, the individual may have arrived at the health map of FIG. 1 by entering one or more keywords. In yet another embodiment, a combination of all three techniques may be used to arrive at the health map of FIG. 1.

Each health map indicates the treatment process broken up into a series of steps. An individual step may consist of a procedure, an operation, an evaluation of a condition, question, test result, or the availability of clinical trials or other goods or services.

Selection of an individual block on a map causes one of a number of possible results. In one case, selection of an individual block results in another page of information being displayed. In one embodiment, this selection causes the client to generate a request from another web page from the server over the Internet. The server responds by sending the web page. The page that is displayed may include more detailed information about the step. Such information may be in the form of text or another health map.

In one embodiment, selection of an individual block or point on the map results in a change in the navigational tools (e.g., links) for the remainder of the site. In such a case, each point on the map has specific attributes that are electronically assigned to other links throughout the web site when that point is selected. These links with assignable attributes may be an interface for different categories of information, goods, and services related to points on the map. In one embodiment, the assignable links may have no attributes (i.e., they are not active links) until a point on the map is selected.

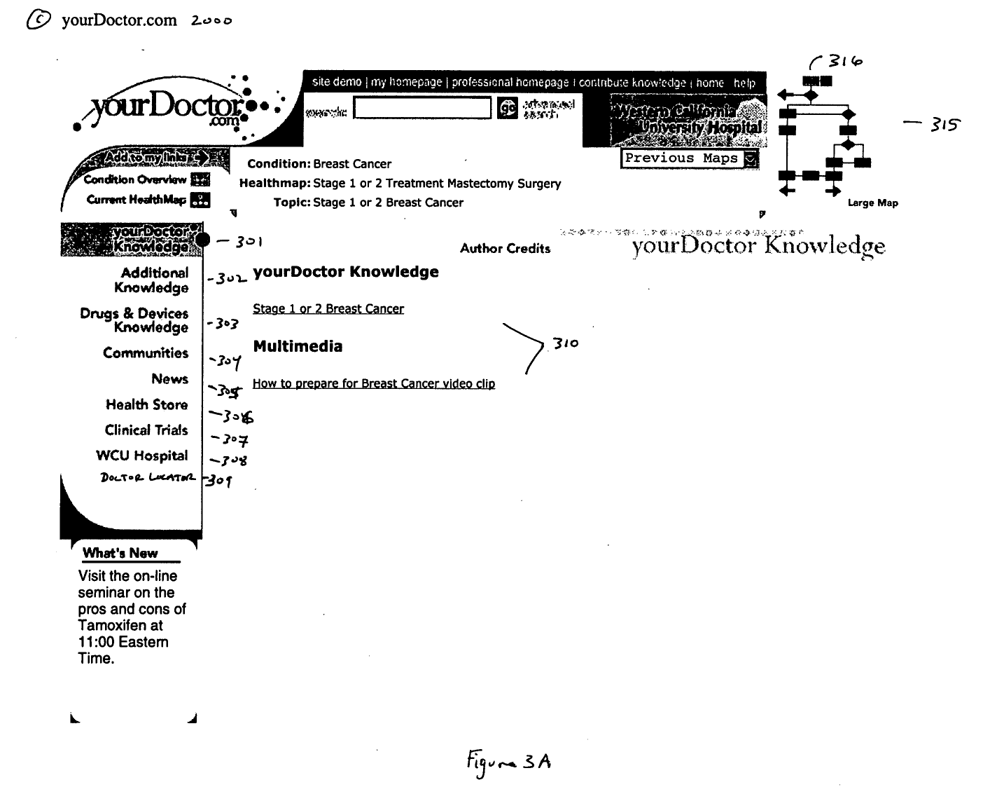

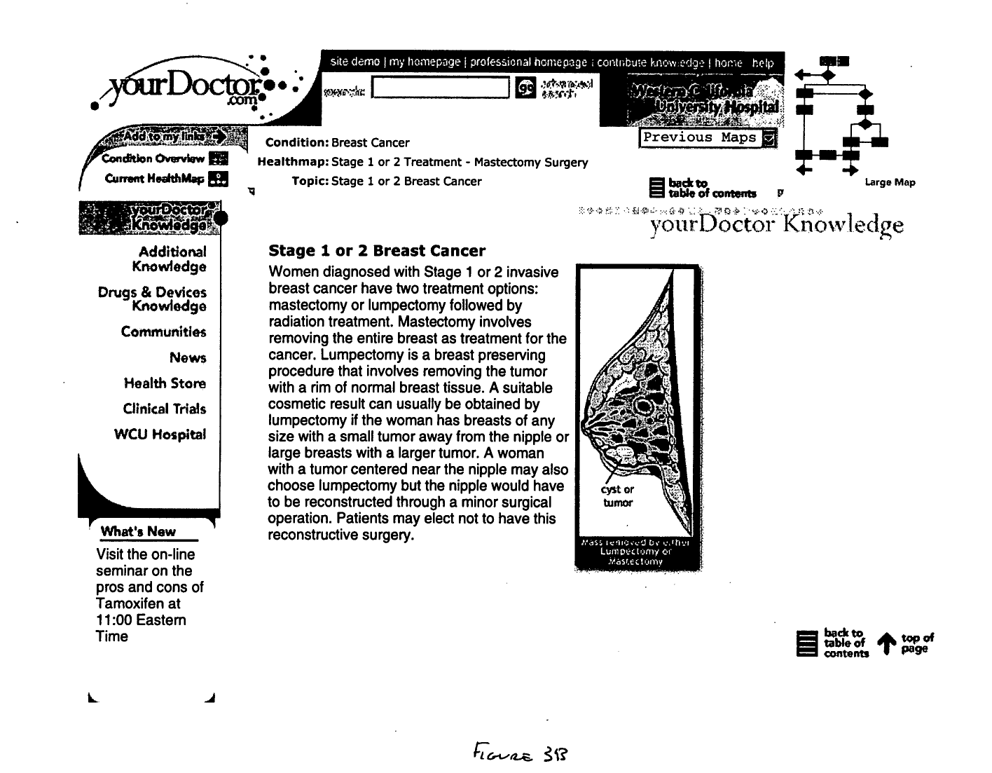

In one embodiment, a reduced-resolution image of the treatment flow diagram corresponding to the health map from which the individual transitioned is also shown. The image may provide an indication of which step in the treatment flow the individual selected in order to arrive at the current page. For example, the block that was selected to cause the current page to be displayed may be a different color than the remaining blocks. In one embodiment, selection of another step in the reduced-resolution image of the treatment flow diagram causes a page corresponding to that step to be displayed. An example of such a page with the reduced-resolution map is shown in FIG. 3A. Again, the page may be a web page sent as a response to a request to a server over the Internet.

An interface to different categories of information may also be displayed. In one embodiment, the interface comprises a series of selectable buttons. FIG. 3A illustrates an example of such a series of buttons. Selection of each of the buttons in the interface causes the display of information for that category of information identified in the interface. Thus, the buttons act as a portal to access one or more specific categories of information, goods, and services according to the point on the map which has been selected.

Referring to FIG. 3A, the buttons include a knowledge button 301, an additional knowledge button 302, a communities button 303, a news button 304, a drugs & devices button 305, a health store button 306, a clinical trials button 307, a doctor locator button 308, and one or more other sponsored buttons, such as, for example, Ford 309.

Knowledge button 301 and additional knowledge button 302 represent physician content buttons. Selection of either of knowledge buttons 301 and 302 provides an individual with access to content on a specific subject matter. The content provided when knowledge button 301 is selected is trusted content. In one embodiment, trusted content is content that has been added to the navigation system by a licensed physician, has been edited, and has undergone peer review. An example of 2 articles 310 of trusted content are shown in FIG. 3A. Selection of the first link causes the display of the page shown in FIG. 3B.

The content provided when knowledge button 302 is selected is content that is not trusted. In one embodiment, this non-trusted content may comprise content that has been added by a licensed physician but has not undergone editing nor peer review.

In one embodiment, knowledge buttons 301 and/or 302 may provide research information that an individual may access or other additional information that would help an individual understand the subject matter, such as, for example, a dictionary.

Selection of drugs & devices button 303 provides an individual access to prescription drugs and devices associated with the topic the individual selected in the health map.

Selection of communities button 304 provides an individual access to specific communications regarding a particular subject matter. In one embodiment, selection of the communities button 304 provides a user access to a chat room in which the communications are about the topic that the individual selected in the health map. For example, if the individual is a patient interested in stage III melanoma, a simple selection of communities button 304 gives the individual access to a chat room in which the discussion topic is stage III melanoma. This is particular advantageous in that the individual does not have to wade through many different conversations in one or more chat rooms to locate conversations that are in context in which the individual is currently interested, perhaps because the individual is at a particular stage in treatment.

In one embodiment, the activities associated with each map node can be utilized to derive revenue streams associated with the navigational system. Much as stores in real communities tend to cater to the needs of the residents of their community, the “stores” attached to the navigational system are customizable to the needs of the users in that virtual community. As a result, an e-commerce location becomes a contextual kiosk for the goods of interest to the defined user community. Similarly, the community-specific chat rooms may be sponsored by entities and/or individuals having a direct pecuniary interest in the specific community of users served to create a revenue stream associated with the navigation system.

Selection of news button 305 provides an individual access to news stories and feature articles from the press regarding the topic the individual selected in the health map.

Selection of health store button 306 provides an individual access to specific products related to the topic the individual selected in the health map.

Selection of clinical trials button 307 provides an individual access to information regarding clinical trials for a particular subject area (e.g., Stage III melanoma). In one embodiment, the information includes the eligibility requirements for these clinical trials. In another embodiment, an individual may indicate their desire to enter one or more clinical trials after reviewing the information on the clinical trials. Such an indication may be made automatic by allowing the user to select a button or other icon on the display. In one embodiment, the selection on the display causes the navigation system to prompt the individual for information that allows the system to determine if the individual is eligible for the trial. The system may be configured to provide the information to the staff of a clinical trial automatically on behalf of the individual. The information may be provided confidentially so that the staff of the clinical trial is not made aware of the individual's identify until eligibility requirements have been met. By its nature, the specificity of the map defines a user group for whom a particular clinical trial is of relevance. As a result, the navigational system, by itself, provides a matching function between users and providers.

Selection of a sponsored button, such as, for example, WCU Hospital 308, provides an individual with access to content provided by a specific sponsor.

Selection of doctor locator button 309 provides an individual information regarding doctors that specialize in the topic selected by the individual on the health map.

It should be understood that the interface may have more or less buttons depending on the implementation. For example, the interface may have buttons for healthcare insurers, HMO's, PPO's, Universities, Hospitals, and even one called “advertisers”. Companies or institutions can pay to have information put on the web site and attached to a particular point on a map. Also, they can pay to have a left-hand button if they want.

In one embodiment, the page may provide a reduced-resolution image of the map, such as map 315 in FIG. 3A, as well as an indication of which block, such as block 316, in the health map that was selected.

In another embodiment, each page displayed may include advertisements on a portion of a page. The use of advertisements would result in a revenue stream from various entities and/or individuals interested in having their advertisements on the page. The advertising may be targeted to a specific audience because the content that the individual is accessing information is on a specific subject. For example, if there is a drug for a specific medical condition, the advertisement of that drug may be shown to those who access content related to the specific medical condition.

An Embodiment of the Navigation System

The navigation system operates by setting up a context that is based on which diagram (e.g., health map) is being displayed, which node in the diagram has been selected, and which category of content has been selected in an interface on the display. Based on this context, a rule-based system accesses a database to retrieve the content associated with the context.

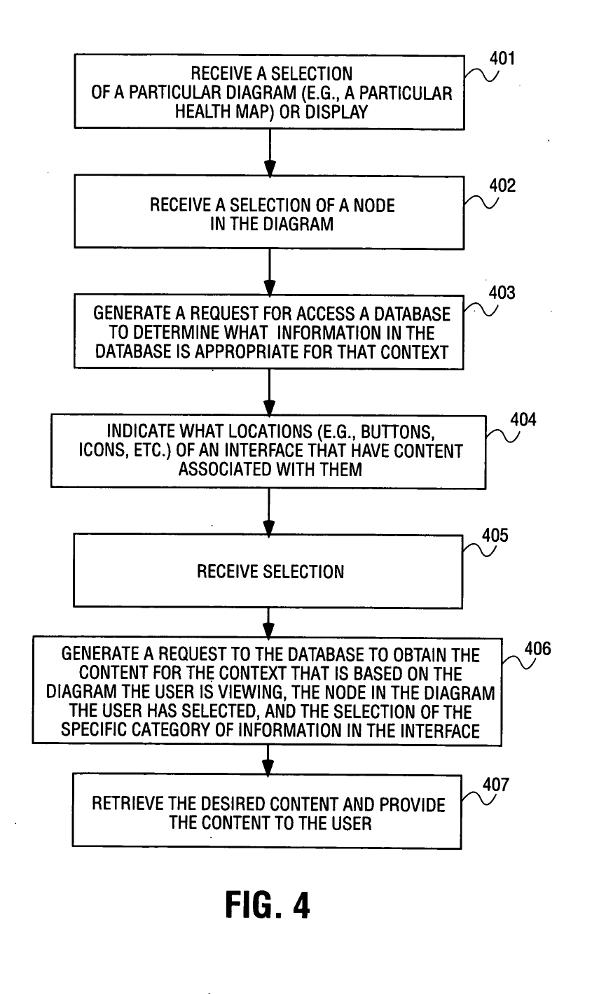

In one embodiment, FIG. 4 is a flow diagram of the process. The process may be performed by processing logic that may comprise hardware, software or a combination of both.

Referring to FIG. 4, the process begins with the navigation system receiving a selection of a particular diagram (e.g., a particular health map) or display (processing block 401). In the case of a health map, the selection may be the result of the system initially displaying a page listing many general categories of diseases, receiving a selection from the user of one of the diseases, retrieving a new page and/or content for the selected disease from a database, and displaying that page.

Next, the system receives a selection of a node in the diagram (processing block 402). Based on the selection of the diagram and a node in the diagram, the system, employing a rule-based analysis, generates a request for and accesses a database to determine what information in the database is appropriate for that context (processing block 403). Using the information, the system may indicate what locations (e.g., buttons, icons, etc.) of an interface, such as the one in FIG. 3A, that have content associated with them and, thus, should be active (processing block 404). The activation performed by the system may comprise changing the color or otherwise highlighting active locations.

Note that processing blocks 403 and 404 are optional and a determination of which locations of the interface are active prior to selection of one of the locations is not necessary.

The system waits for the user to select another area. The system receives a selection (processing block 408) and generates a request to the database to obtain the content for the context that is based on the diagram the user is viewing, the node in the diagram the user has selected, and the selection of the specific category of information in the interface (processing block 406). The system then retrieves the desired content and provides the content to the user (processing block 407).

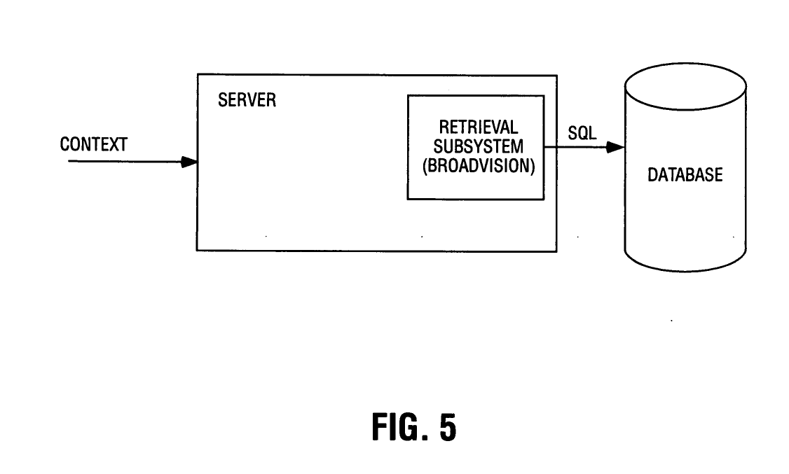

In one embodiment, the retrieval subsystem of the navigation system to access the database containing the content generates one or more SQL statements based on the context to access the content which is stored in a relational database. In one embodiment, the retrieval subsystem uses software, such as, for example, Broadvision, as an interface to generate the SQL statements to access the database. Such an arrangement is shown in FIG. 5.

The retrieval subsystem may also allow for storing content received by the navigation system. For example, in one embodiment, if a physician desires to add content so that individuals may access the content when selecting a particular location in a particular map, the physician goes to that map and selects a specific location on the map and then enters a text (and graphics) during an addition mode that enables the physician to add or attach a document to the other content. The content is made accessible under of the interface buttons, such as the additional knowledge button 302. Upon receiving the content, the software creates a rule for accessing the content (e.g., when an individual selects the particular button when selecting a location on a map) and then stores the content so that it is accessible when the rule is trigger due to an individual navigating the site.

An Exemplary Network Architecture

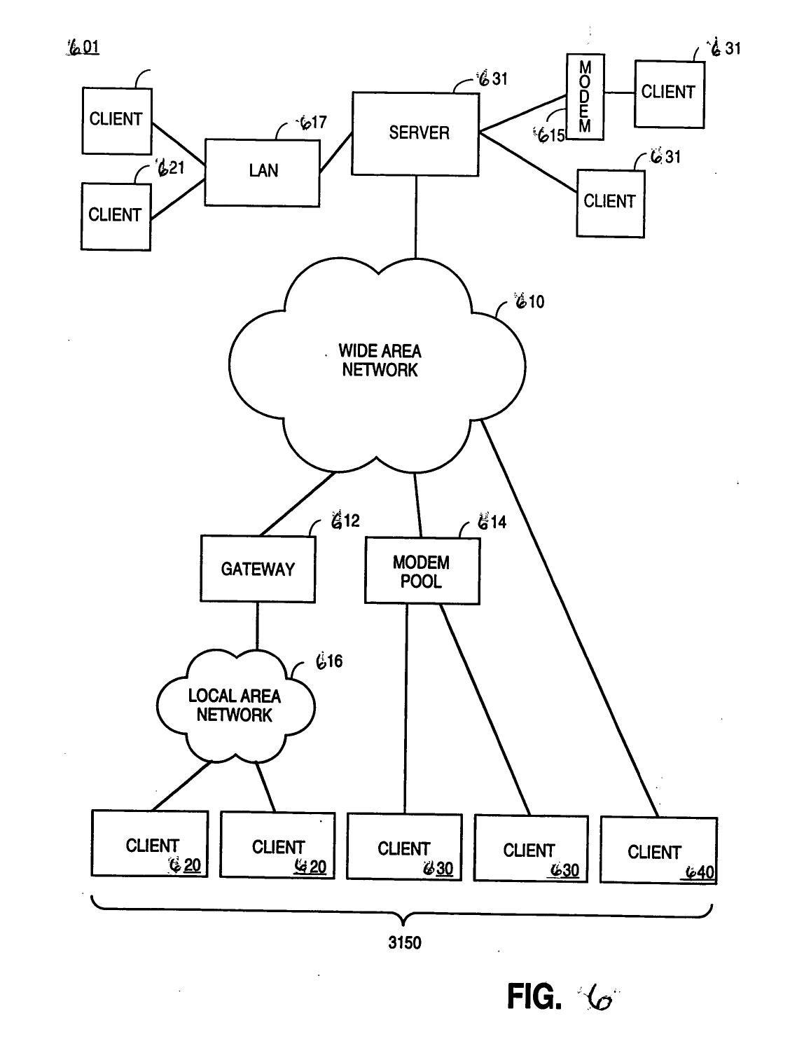

FIG. 6 is a block diagram of one embodiment of a network environment 601 that may be used for the navigation system. In one embodiment, a server computer system 600 is coupled to a wide-area network 610. Wide-area network 610 may include the Internet or other proprietary networks including, but not limited to, America On-Line™, CompuServe™, Microsoft Network™, and Prodigy™. Wide-area network 610 may include conventional network backbones, long-haul telephone lines, Internet and/or Intranet service providers, various levels of network routers, and other conventional mechanisms for routing data between computers. Using network protocols, server 600 may communicate through wide-area network 610 to client computer systems 620, 630, 640, which are possibly connected through wide-area network 610 in various ways or directly connected to server 600. For example, client 640 is connected directly to wide-area network 610 through direct or dial up telephone or other network transmission line.

Alternatively, clients 630 may be connected through wide-area network 610 using a modem pool 614. Modem pool 614 allows multiple client systems to connect with a smaller set of modems in modem pool 614 for connection through wide-area network 610. Clients 631 may also be connected directly to server 600 or be coupled to server through modem 615. In another alternative network typology, wide-area network 610 is connected to a gateway computer 612. Gateway computer 612 is used to route data to clients 620 through a local area network 616. In this manner, clients 620 can communicate with each other through local area network (LAN) 616 or with server 600 through gateway 612 and wide-area network 610. Alternatively, LAN 617 may be directly connected to server 600 and clients 621 may be connected through LAN 617.

Using one of a variety of network connection mechanisms, server computer 600 can communicate with client computers 650. In one embodiment, a server computer 600 may operate as a web server if the World-Wide Web (“WWW”) portion of the Internet is used for wide area network 610. Using the HTTP protocol and the HTML coding language, such a web server may communicate across the World-Wide Web with clients 650. In this configuration, clients 650 use a client application program known as a web browser such as the Netscape Navigator™, the Internet Explorer™, the user interface of America On-Line™, or the web browser or HTML translator of any other conventional supplier. Using such browsers and the World Wide Web, clients 650 may access graphical (e.g., health maps) and textual (e.g., health care content) provided by the web server 600.

In one embodiment, server 600 contains a database that stores the health maps and other health care content to facilitate use of the navigation system.

An Exemplary Computer System

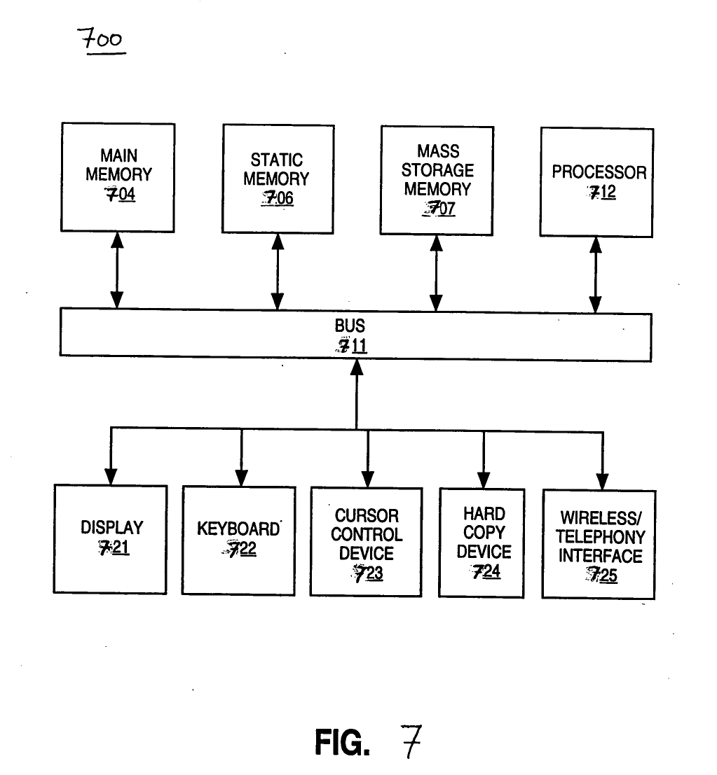

FIG. 7 is a block diagram of an exemplary computer system that may be used as the client or server in the navigation system. Referring to FIG. 7, computer system 700 may comprise an exemplary client 650 or server 600 computer system in which the features of the present invention may be implemented. Computer system 700 comprises a communication mechanism or bus 711 for communicating information, and a processor 712 coupled with bus 711 for processing information. Processor 712 includes a microprocessor, but is not limited to a microprocessor, such as Pentium™, PowerPC™, Alpha™, etc.

System 700 further comprises a random access memory (RAM), or other dynamic storage device 704 (referred to as main memory) coupled to bus 711 for storing information and instructions to be executed by processor 712. Main memory 704 also may be used for storing temporary variables or other intermediate information during execution of instructions by processor 712. In one embodiment, main memory 704 has a portion of its memory allocated for storing various documents downloaded from the server system of the navigation system.

Computer system 700 also comprises a read only memory (ROM) and/or other static storage device 706 coupled to bus 711 for storing static information and instructions for processor 712, and a data storage device 707, such as a magnetic disk or optical disk and its corresponding disk drive. Data storage device 707 is coupled to bus 711 for storing information and instructions.

Computer system 700 may further be coupled to a display device 721, such as a cathode ray tube (CRT) or liquid crystal display (LCD), coupled to bus 711 for displaying information to a computer user. An alphanumeric input device 722, including alphanumeric and other keys, may also be coupled to bus 711 for communicating information and command selections to processor 712. An additional user input device is cursor control 723, such as a mouse, trackball, trackpad, stylus, or cursor direction keys, coupled to bus 711 for communicating direction information and command selections to processor 712, and for controlling cursor movement on display 721.

Another device which may be coupled to bus 711 is hard copy device 724, which may be used for printing instructions, data, or other information on a medium such as paper, film, or similar types of media. Furthermore, a sound recording and playback device, such as a speaker and/or microphone may optionally be coupled to bus 711 for audio interfacing with computer system 700. Note that any or all of the components of system 700 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

1. A system comprising:
a relational database system containing a plurality of disease specific diagnosis and treatment algorithms, each of the plurality of algorithms comprises a plurality of diagnosis/treatment steps in a diagnosis or treatment of a disease, each diagnosis/treatment step being associated with one or more of the following inputs: a keyword or key phrase pertinent to the diagnosis/treatment step, a medical procedure code pertinent to the diagnosis/treatment step, a billing procedure code pertinent to the diagnosis/treatment step, a drug pertinent to the diagnosis/treatment step, a diagnostic or surgical procedure pertinent to the diagnosis/treatment step; and
a server in communication with the relational database system;
the database system further containing a plurality of disease information components, each of the disease information components comprising descriptive information about one of the diagnosis/treatment steps;
the database system and server being adapted and configured to enable a user to navigate a disease process and gain access to the descriptive information about one of the diagnosis/treatment steps upon inputting one or more of the inputs associated with such diagnosis/treatment step.

2. A system as set forth in claim 1 wherein each diagnosis/treatment step is associated with two or more of the following inputs: a keyword or key phrase pertinent to the diagnosis/treatment step, a medical procedure code pertinent to the diagnosis/treatment step, a billing procedure code pertinent to the diagnosis/treatment step, a drug pertinent to the diagnosis/treatment step, a diagnostic or surgical procedure pertinent to the diagnosis/treatment step.

3. A system as set forth in claim 1 wherein each diagnosis/treatment step is associated with a medical procedure code pertinent to the diagnosis/treatment step.

4. A system as set forth in claim 1 wherein each diagnosis/treatment step is associated with a billing procedure code pertinent to the diagnosis/treatment step.

5. A system as set forth in claim 1 wherein each diagnosis/treatment step is associated with a drug pertinent to the diagnosis/treatment step.

6. A system as set forth in claim 1 wherein each diagnosis/treatment step is associated with a diagnostic or surgical procedure pertinent to the diagnosis/treatment step.

7. A system as set forth in claim 1 wherein each of at least some of the disease information components comprises information about drugs pertinent to the diagnosis/treatment step.

8. A system as set forth in claim 1 wherein each of at least some of the disease information components comprises information about conditions pertinent to the diagnosis/treatment step.

9. A system as set forth in claim 1 wherein each of at least some of the disease information components comprises information about medical devices pertinent to the diagnosis/treatment step.

10. A system comprising:
a server, the server being adapted and configured to retrieve healthcare information from at least one database and send the healthcare information via the Internet to a client computer in a manner to cause the client computer to display a hierarchical series of windows with each window of the series of windows containing information about a step of a disease symptom, diagnosis or treatment, the hierarchical series of windows combining to provide information about a plurality of symptom, diagnosis or treatment steps of a disease.

11. A system as set forth in claim 10 wherein:
the hierarchical series of windows comprises a first hierarchical series of windows with each window of the series of windows containing information about a step of a disease symptom, the first hierarchical series of windows combining to provide information about a plurality of symptom steps of a first disease; and
the server is further adapted and configured to send the healthcare information via the Internet to the client computer in a manner to cause the client computer to display a second hierarchical series of windows with each window of the second hierarchical series of windows containing information about a step of a disease treatment, the second hierarchical series of windows combining to provide information about a plurality of treatment steps of the first disease.

12. A method comprising:
providing a server that is adapted and configured to retrieve healthcare information from at least one database and send the healthcare information via the Internet to a client computer;
retrieving the healthcare information via the server and sending the healthcare information to the client computer via the server in a manner to cause the client computer to display a hierarchical series of windows with each window of the series of windows containing information about a step of a disease symptom, diagnosis or treatment, the hierarchical series of windows combining to provide information about a plurality of symptom, diagnosis or treatment steps of a disease.

13. A method as set forth in claim 12 wherein the step of retrieving the healthcare information via the server and sending the healthcare information to the client computer via the server comprises sending the healthcare information to the client computer via the server in a manner to cause the client computer to display a first hierarchical series of windows and a second hierarchical series of windows, each window of the first hierarchical series of windows containing information about a step of a disease symptom, the first hierarchical series of windows combining to provide information about a plurality of symptom steps of a first disease, each window of the second hierarchical series of windows containing information about a step of a disease treatment, the second hierarchical series of windows combining to provide information about a plurality of treatment steps of the first disease.

14. A method as set forth in claim 12 wherein:
the hierarchical series of windows comprises first, second and third windows, the first window containing information about a first step of a disease treatment for a disease, the second window containing information about a second step of a disease treatment for the disease, the third window containing information about a third step of the disease treatment for the disease, the second step being different than the first step, the third step being different than the first step and different than the second step;
the server causing the client computer to serially display the first, second and third windows such that the windows combine to provide a treatment progression of the disease.

15. A method as set forth in claim 14 wherein:
the server causes the second window to be displayed on the client computer in response to a user of the client computer selecting an icon on the first window;
the server causes the third window to be displayed on the client computer in response to the user of the client computer selecting an icon on the second window.
